(19) United States
(12) Patent Application Publication
(10) Pub. No.: US 2025/0302075 A1
(43) Pub. Date: Oct. 2, 2025

(54) COMPOSITIONS AND METHODS OF PREPARATION OF A CLEAR, EFFERVESCENT DELIVERY FORM FOR NUTRITIONAL INGREDIENTS

(71) Applicant: TSI Group Co., Ltd., Jiangyin (CN)

(72) Inventors: Will Ji, Xuzhou (CN); Bicong Chen, Xuzhou (CN); Shawn Baier, Polk City, IA (US); Zhu Yao, Xuzhou (CN)

(73) Assignee: TSI Group Co., Ltd., Jiangyin (CN)

(21) Appl. No.: 19/097,651

(22) Filed: Apr. 1, 2025

Related U.S. Application Data
(60) Provisional application No. 63/572,479, filed on Apr. 1, 2024.

(51) Int. Cl. A23L 2/40; A23L 2/395; A23L 2/68

(52) U.S. Cl. CPC A23L 2/40; A23L 2/395; A23L 2/68

(57) ABSTRACT

This disclosure relates to a delivery system for nutritional ingredients. The system may comprise an effervescent dosage form for delivery of one or more active ingredients, comprising a core comprising the one or more active ingredients; one or more concentric layers surrounding the core, wherein at least one of the one or more concentric layers comprises an effervescing agent, wherein the outermost concentric layer is configured to exclude environmental moisture. Upon dissolution in water, the pellets rapidly disperse without visible residue, films, or precipitates, enabling improved palatability, solubility, and stability of otherwise poorly soluble nutritional compounds.

### CROSS-REFERENCES & RELATED APPLICATIONS

This application claims priority to U.S. Provisional Application No. 63/572,479 filed Apr. 1, 2024, and entitled “COMPOSITIONS AND METHODS OF PREPARATION OF A CLEAR, EFFERVESCENT DELIVERY FORM FOR NUTRITIONAL INGREDIENTS,” which is hereby incorporated by reference in its entirety under 35 U.S.C. § 119(e).

### TECHNICAL FIELD

The disclosure relates to food and health products.

### BACKGROUND

Traditional solid dosage delivery forms for nutritional supplements, vitamins, and pharmaceuticals can present difficulties, such as an inability or unwillingness to chew or swallow pills or tablets. If people have difficulty swallowing larger pills or tablets, smaller dosing capacities have to be employed to limit the size of the solid dosage form, which results in the need to consume the dosage in many pills or tablets. Slow dissolution times in the body also can result in poor absorption of the active ingredients. To overcome the issues with pills and tablets, new categories of delivery systems are increasing in consumer popularity, including powders, gummies, liquids and effervescent materials. Non-pill delivery forms still have significant shortcomings, including lower active ingredient levels and/or limited active loading capacity, weak shelf life and lack of convenience.

Effervescence is emerging as a non-pill delivery technology that is popular with consumers. In a typical use of effervescent technology, a large effervescent tablet or a measured amount of effervescent powder containing active ingredients is dissolved in water or other liquids. Effervescent tablets usually contain acidic substances and carbonate or bicarbonates which react rapidly to release carbon dioxide when dissolved in liquid. One of the earliest commercial examples of effervescence for the delivery of active ingredients is Alka-Seltzer for the treatment of upset stomach. This traditional effervescent delivery form is a large tablet that is deposited into a liquid, such water. The tablet dissolves, creating a bubbly beverage. The consumer drinks the beverage after the tablet has dissolved.

Effervescent formulations provide many benefits, including the ability to be quickly and uniformly absorbed when consumed. Traditional effervescent delivery forms present problems such as lower active ingredient levels and/or limited active ingredient loading. The effervescent delivery form needs to dissolve relatively quickly and provide a product that is palatable to the consumer. Many ingredients do not dissolve completely when the effervescent tablet is added to liquids such as water. The result is an oily film on top of the liquid and sediment precipitating from the liquid. The film and sediment impact palatability of the product. It is therefore desired to have a product in which the effervescent technology completely dissolves quickly after being placed in water, resulting in a clear liquid substantially free of films or sediment.

### BRIEF SUMMARY OF THE INVENTION

This disclosure is directed to a novel delivery system that can be used to deliver nutritional ingredients, such as amino acids, vitamins and minerals. The presently disclosed technology resolves poor water solubility of nutritional ingredients. Once the effervescent pellets are placed in liquids, such as water, the pellets quickly completely dissolve, resulting in a substantially clear liquid free from sediment and/or films.

Embodiment 1 relates to an effervescent dosage form for delivery of one or more active ingredients comprising a core an active ingredient; one or more concentric layers surrounding the core, wherein at least one of the one or more concentric layers comprises an effervescing agent, wherein the outermost concentric layer is configured to exclude environmental moisture.

Embodiment 2 relates to Embodiments 1 and 3-8, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

Example 3 relates to Examples 1-2 and 4-8, wherein the core further comprises one or more binders.

Embodiment 4 relates to Embodiments 1-3 and 5-8, wherein the binders are chosen from the list consisting of starch, maltodextrin, gum arabic, HPMC, HPC, chitosan, sodium alginate, and casein.

Embodiment 5 relates to Embodiments 1-4 and 6-8, wherein the intermediate layer comprises effervescent agents.

Embodiment 6 relates to Embodiments 1-5 and 7-8, wherein the effervescent agents comprise acids and bases.

Embodiment 7 relates to Embodiments 1-6 and 8, wherein the acids are chosen from the list consisting of citric acid, malic acid, and tartaric acid, and wherein the base is sodium bicarbonate.

Embodiment 8 relates to Embodiments 1-7, wherein the core comprises effervescent agents.

Embodiment 9 relates to a method of producing an effervescent dosage form, in these embodiments referred to as effervescent pellets, comprising mixing raw materials with one or more binders to produce an unextruded mixture, the raw materials comprising an active ingredient, an acid, and a base; extruding the unextruded mixture to produce cylindrical rods; spheronizing the cylindrical rods to produce raw microspheres; drying the raw microspheres to produce microspheres; coating the microspheres with an outer film to produce effervescent pellets.

Embodiment 10 relates to Embodiments 9 and 11-14, further comprising spraying an additional portion of one or more binders, an additional portion of an acid, and an additional portion of a base onto the microspheres.

Embodiment 11 relates to Embodiments 9-10 and 12-14, wherein the raw materials are crushed.

Embodiment 12 relates to Embodiments 9-11 and 13-14, wherein the raw materials are screened through a mesh sieve, the mesh sieve being about 60 mesh to about 100 mesh.

Embodiment 13 relates to Embodiments 9-12 and 14, wherein the binders are chosen from the list consisting of starch, maltodextrin, gum arabic, HPMC, HPC, chitosan, sodium alginate, and casein

Embodiment 14 relates to Embodiments 9-13, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

Embodiment 15 is related to a method of producing effervescent pellets comprising combining a primary mixture with a shaping aid, the primary mixture comprising an active ingredient, an acid, and a base; granulating the primary mixture in a centrifugal granulator to produce raw microspheres; spraying a binder onto the raw microspheres to produce microspheres; coating the microspheres to produce effervescent pellets.

Embodiment 16 relates to Embodiments 15 and 17-20, further comprising mixing raw materials together to produce the primary mixture; the raw materials comprising the active ingredient, the acid, and the base.

Embodiment 17 relates to Embodiments 15-16 and 18-20, wherein the raw materials are crushed.

Embodiment 18 relates to Embodiments 15-17 and 19-20, wherein the raw materials are screened through a mesh sieve, the mesh sieve being about 40 mesh to about 80 mesh.

Embodiment 19 relates to Embodiments 15-18 and 20, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

Embodiment 20 relates to Embodiments 15-19, wherein the shaping aid is chosen from the list consisting of starch, maltodextrin, and gum Arabic.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF DRAWINGS

FIG. 1A shows a cross section of the effervescent pellet with a core, intermediate layer, and an outer coating, according to one implementation.

FIG. 1B shows a cross section of the effervescent pellet with a core and intermediate layer, according to one implementation.

FIG. 1C shows a cross section of the effervescent pellet with a core and an outer coating, according to one implementation.

FIG. 2 is a flowchart of an extrusion method for producing effervescent pellets, according to one implementation.

FIG. 3 is a flowchart of a centrifugal granulation method for producing effervescent pellets, according to one implementation.

FIG. 4 shows effervescent pellets that may be produced through the extrusion method or granulation method, according to one implementation.

FIG. 5 shows effervescent pellets that may be produced through the extrusion method, according to one implementation.

FIG. 6 shows the solubility of the effervescent pellets compared to triplicate controls, according to one implementation.

FIG. 7 shows effervescent pellets that may be produced through the centrifugal granulation method, according to one implementation.

FIG. 8 shows alternative effervescent pellets that may be produced through the extrusion method, according to one implementation.

FIG. 9 shows a visual comparison of the dissolution effects between the effervescent pellets and the control group, according to one implementation.

### DETAILED DESCRIPTION

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Before the present compounds, compositions, articles, systems, devices, and/or methods are disclosed and described, it is to be understood that they are not limited to specific synthetic methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

As used herein, “mesh” and “mesh size” refer to US standard mesh sizes, unless otherwise specified. Such mesh sizes are known to those in the art as a measurement of particle size of bulk material.

The various formulations and methods disclosed herein are part of a system 1 for improving the solubility or stability of active ingredients in effervescent pellets 10. The increased solubility of the active ingredients in the system 10 may improve various aspects of the active ingredients upon ingestion by a subject. The aspects may be increased absorption into the body, increase speed of absorption into the body, improved palatability, and various other aspects that may be known to those in the art.

In certain embodiments, this disclosure is directed to effervescent dosage form 10 that may be formed by a core 12 with one or more concentric layers. The effervescent dosage forms 10, through the various embodiments disclosed herein, may comprise a core 12 with between one and four concentric layers. In certain embodiments, the effervescent dosage forms 10 may have more than four concentric layers. In still further embodiments, the effervescent dosage forms 10 may be formed by a core 12 with no concentric layers.

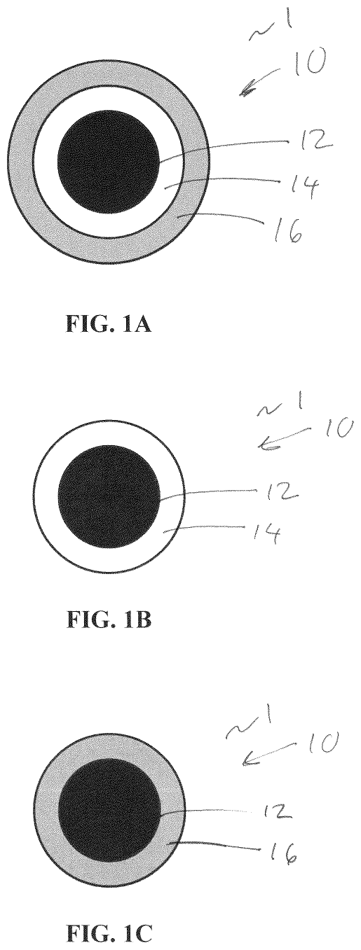

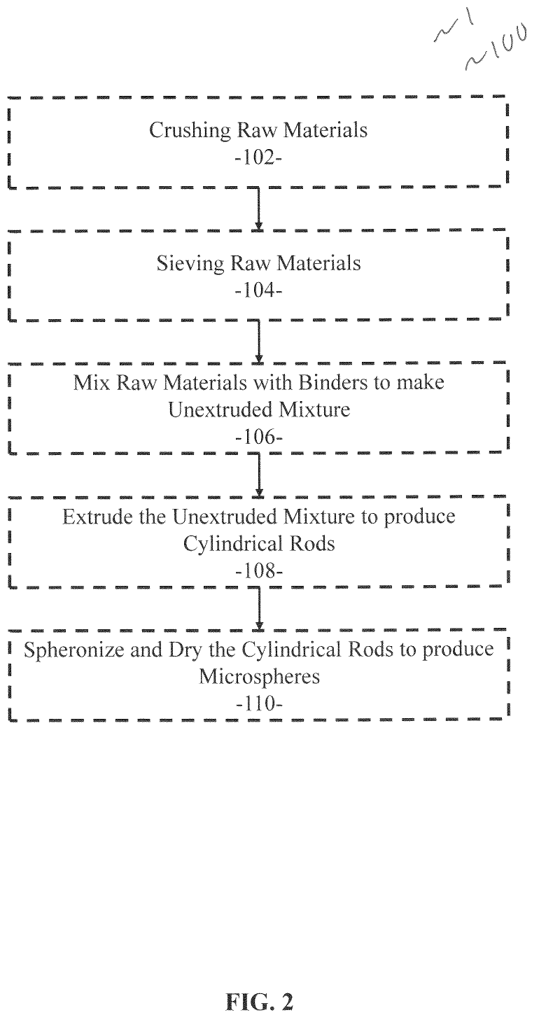

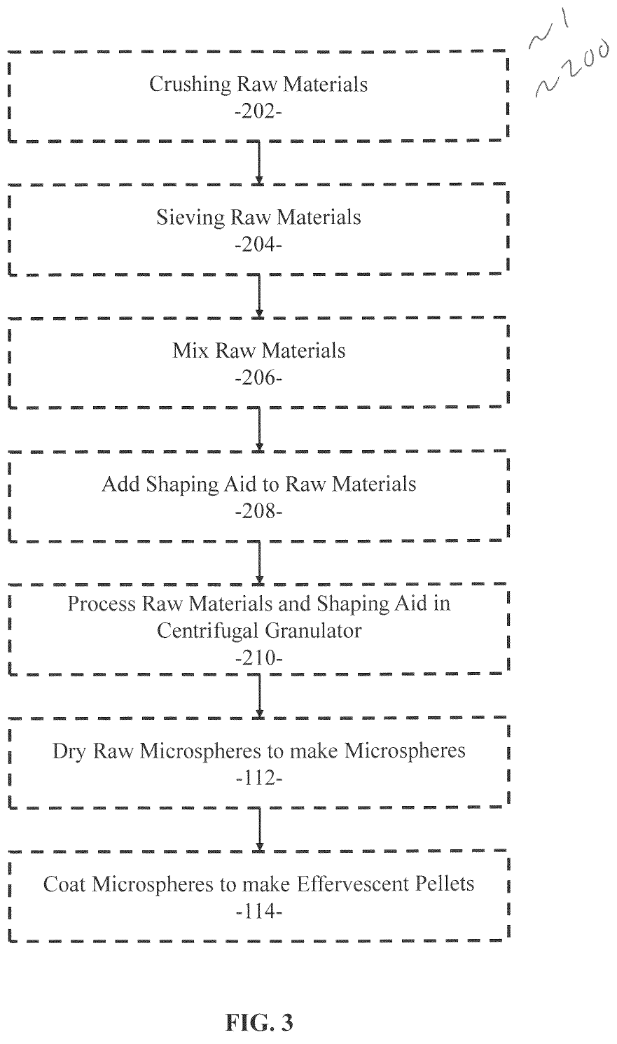

In certain embodiments, the concentric layers may comprise a surrounding intermediate layer 14 and possibly a further surrounding an outer film 16, such as shown in FIG. 1A. In other embodiments with the concentric layers may be an intermediate layer 16, such as shown in FIG. 1B. In still further embodiments, the concentric layers may comprise an outer film 16, such as shown in FIG. 1C.

In certain embodiments, the effervescent dosage forms 10 may be pellets, spheroids, microparticle, ellipsoids, particles, or other similar shapes. In various embodiments, the effervescent dosage forms 10 may have a diameter of about 0.5 mm to about 8 mm. In some embodiments, the effervescent dosage forms 10 may have a diameter of about 0.5 mm to about 3 mm.

In various embodiments, the effervescent dosage forms 10 may be colored, colorless, translucent, opaque, scented, unscented, flavored, and unflavored.

In various embodiments, the effervescent dosage forms 10 may be configured to deliver nutraceutical or dietary supplement ingredients selected from amino acids, proteins, vitamins, minerals, endogenous bioactive substances, herbs, herbal extracts, and their salts, active precursors, derivatives, isomers, isotopes, hydrates, chelates, or polymers.

In various embodiments, the outer film 16 is formed from a film-forming material that protects the intermediate layer 14 and core 12 from environmental contamination, such as environmental moisture, which may increase stability and shelf-life. The outer film 16 may be sprayed onto the intermediate layer 14, whereby it can dry into a protective film. In some embodiments, the outer film 16 is made of a binder. In further embodiments, the outer film 16 may be made of a binder and an effervescent agent, which are discussed in detail below. The binder may be but is not limited to starch, maltodextrin, gum arabic, HPMC, HPC, chitosan, sodium alginate, and/or casein. The outer film 16 may also contain various flavors, sweeteners, and/or colors.

Various techniques may be used to apply the outer layer 16, such as but not limited to pan coating, spray coating, fluid bed coating, and similar technologies that would be known to those of skill in the art.

In various embodiments, the core 12 may contain active ingredients that are meant to be delivered to a patient or subject. Examples of active ingredients may be but are not limited to branched-chain amino acids (BCAAs), creatine (and hydrates thereof), sodium hyaluronate (HA), β-hydroxy-β-methylbutyrate (HMB) (and salts thereof), amino acids, mineral chelates of amino acids, vitamins, minerals, peptides, proteins, L-carnitine, paraxanthine, dietary fiber, and/or glutathione.

The core 12 may also contain binders, shaping aids, and/or effervescent agents-non-exclusive examples of the effervescent agents being acids and bases. The binders may be included in the core to provide cohesion and structural integrity to the core by adhering the various components to one another. The core 12 may also contain various flavors, sweeteners, and/or colors.

The shaping aids, which may be but are not limited to starch, maltodextrin, and/or gum arabic, may be included in the core to allow for better reshaping properties, such as during spheronization, which will be discussed in detail below.

The effervescent agents, in various embodiments, may include acids and bases. The acids, in certain embodiments can include citric acid, malic acid, and/or tartaric acid, of course other acids known in the art could be used. The bases, in various embodiments, may be sodium bicarbonate and/or sodium carbonate, of course other bases known in the art could be used. In various embodiments, the effervescent agents provide effervescence through a chemical reaction between or among the effervescent agents to order to produce carbon dioxide gas as a reaction product. The effervescent agents may be included in the core to create effervescence near the active ingredients during use of the effervescent dosage forms 10.

In various embodiments, the core 12 may be surrounded by an intermediate layer 14, which may comprise effervescent agents, binders, shaping aids, flavors, sweeteners, and/or colors. The intermediate layer 14 may provide additional effervescence or may be another source of effervescence.

In various embodiments, the effervescent dosage forms 10 may generate an effervescent reaction upon contact with a solvent. In certain embodiments, the solvent may be selected from water, cold water, ice water, room-temperature water, hot water, hot water not exceeding 45° C., milk, or other similar aqueous fluids.

In some embodiments, the effervescent reaction of the effervescent dosage forms 10 with the solvent may produce some or all of visual effects, auditory effects, olfactory effects, or gustatory/textural effects. In certain embodiments, the visual effects can include some or all of ascending, descending, tumbling, rotating, or colliding motions of the units in the solvent, forming patterned or irregular collective movements, and/or changes in solution color or transparency. In some embodiments, the auditory effects can include some or all of distinct sounds of unit disintegration, effervescent reaction noises, bubble bursting, or collisions between units or with container walls. In some embodiments, olfactory effects can include some or all of distinct aromas selected from neutral, fruity, coffee, tea, or floral scents. In certain embodiments, gustatory or textural effects can include some or all of distinct flavors or textures selected from neutral, sweet, sour, fruity, coffee, tea, raspberry, peach, strawberry, lemon, pineapple, banana, apple, green tea, black tea, or coffee.

In various embodiments, the resulting product of the reaction between the effervescent dosage forms 10 and solvent may be a transparent, stable solution. In certain embodiments, the resulting product of the reaction between the effervescent dosage forms 10 and solvent may be colored or colorless, uniformly or non-uniformly colored, and free of visible precipitates, oil films, floaters, particles, or aggregates.

In some embodiments, the time required for the effervescent dosage forms 10 to dissolve into the solvent may be about 20%-about 90% of the time required of a control group comprising conventional formulations with equivalent composition and quantity under identical conditions. In specific embodiments, the time required for the effervescent dosage forms 10 to dissolve into the solvent may be about 45%-about 80% of the time required of a control group comprising conventional formulations with equivalent composition and quantity under identical conditions.

In various embodiments, the stability under accelerated testing conditions of the active ingredients in the effervescent dosage forms 10 may exceed those of a control group over about six months, where the accelerated testing conditions may be at about 40° C. and about 75% relative humidity. In some embodiments, the stability of the effervescent agents, such as acids and bases, in the effervescent dosage forms 10 under long-term storage conditions may exceed those of a control group over about six months, where the long-term storage conditions may be about 25° C. and about 60% relative humidity. Stability of the effervescent agents may prevent package swelling, as breakdown of the effervescent agents may cause package swelling.

Certain embodiments of the effervescent dosage forms 10 may be formed through an extrusion process 100. The specific steps and order of steps described in this particular extrusion process 100 are only exemplary of the disclosure. For this reason, those skilled in the art would understand that each step may be omitted, and other steps may be added. Additionally, the presented order of the steps may be rearranged as may be required in different embodiments.

The extrusion process 100 may include crushing, grinding, milling, or the like raw materials (box 102) such that they pass through a screen/sieve of a desired mesh size (box 104). In certain embodiments, the desired mesh size may be between 60 mesh and 100 mesh. The raw materials may include some or all of the following: an active ingredient, binders, shaping aids, and effervescent agents.

The extrusion process 100 may also include mixing the raw materials with one or more binders and which thereby may produce an unextruded mixture (box 106). The unextruded mixture may then be extruded to produce cylindrical rods (box 108). The production of the cylindrical rods may be done with various extrusion methods and techniques, such as with a single screw extruder, twin screw extruder, and similar technologies.

The extrusion process 100 may include spheronizing the cylindrical rods to produce microspheres (box 110). As would be understood by those skilled in the art, a spheronizer-a machine capable of spheronizing material-is capable of rolling a material against itself and against the surfaces of the spheronizer to round the material into spheres or approximations thereof. Many spheronizers use a rotating disc within a non-moving, cylindrical chamber to round the material, where the material is pressed and rolled against itself and the cylindrical chamber by the centrifugal and rotational forces of the rotating disc.

During the spheronization process, the microspheres may be simultaneously dried. In certain embodiments, the raw microspheres may lose mass during drying. Without being bound by theory, this lost mass is the mass of the evaporated moisture. The lost mass during drying may be referred to as “loss on drying” or “LOD.” In certain embodiments, the LOD may be between about 5% and about 30%

Certain embodiments of the effervescent dosage forms 10 may be formed through a granulation process 200. The specific steps and order of steps described in this particular granulation process 200 are only exemplary of the disclosure. For this reason, those skilled in the art would understand that each step may be omitted, and other steps may be added. Additionally, the presented order of the steps may be rearranged as may be required in different embodiments.

The granulation process 200 may include crushing, grinding, milling, or the like raw materials (box 202) such that they pass through a screen/sieve of a desired mesh size (box 204). In certain embodiments, the desired mesh size may be between 40 mesh and 80 mesh. The raw materials may include some or all of the following: an active ingredient, binders, shaping aids, and effervescent agents.

The granulation process 200 may include mixing the raw materials for a period of time (box 206). During this mixing, a portion of solvent may be added to the raw materials, which may promote formation of microsphere cores 12. The solvent, in certain embodiments, may be water, but other solvents known in the art may be used. A shaping aid may then be added to the raw materials (box 208). The raw materials and shaping aid may then be processed in a centrifugal granulator to add an intermediate layer 14 to the cores 12 (box 210). In certain embodiments, the microspheres may lose mass during processing in the centrifugal granulator. Without being bound by theory, this lost mass is the mass of the evaporated moisture. In certain embodiments, the LOD during processing in the centrifugal granulator may be between about 5% and about 30%.

The granulation process 200 may then include applying a coating to the microspheres to produce effervescent dosage forms 10. In certain embodiments, the microspheres may be coated to produce an outer film 16.

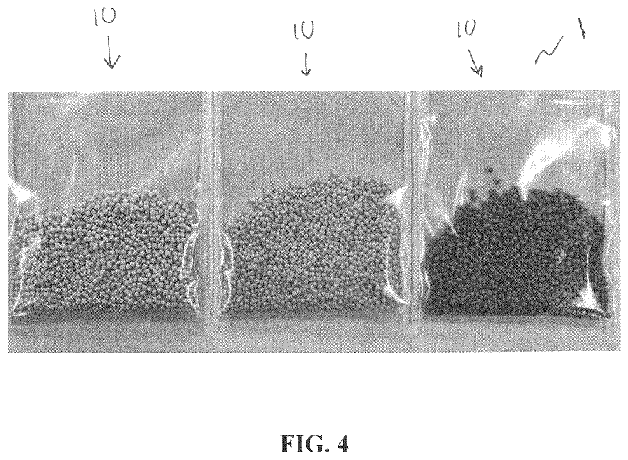

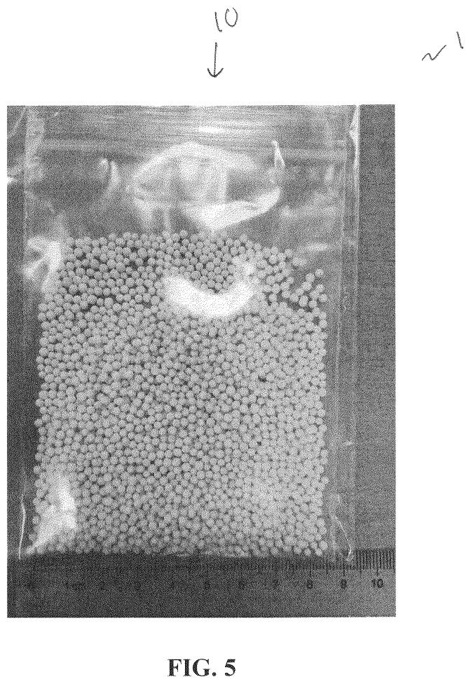

FIG. 4 shows images of effervescent dosage forms 10 that may be produced through the extrusion process 100 or granulation process 200.

### EXAMPLES

### Example 1

In this Example, raw materials were weighed out as given in Table 1, except for 48% of the acid and base, which were set aside.

TABLE 1

| | | Input Percentage |
|---|---|---|
| Components | Function | per Serving |
| Creatine Monohydrate | Active ingredient | 20 |
| CaHMB Monohydrate | Active ingredient | 19 |
| Citric Acid Anhydrous | Effervescent agent | 20 |
| Sodium Bicarbonate | Effervescent agent | 24 |
| Mannitol | sweetener | 3 |
| sorbitol | sweetener | 4 |
| maltodextrin | excipient | 2 |
| HPC | excipient | 1 |
| HPMC | excipient | 2 |
| Natural Strawberry Flavors | flavor | 2 |
| Stevia | sweetener | 2 |
| Natural Fruit and Vegetable | color | 1 |
| Powder | | |
| Total | | 100 |

The raw materials were then passed through a 60 mesh sieve. The acid used was citric acid and the base used was sodium bicarbonate in a 1:1.2 acid to base ratio.

Maltodextrin, Hydroxypropyl methylcellulose (HPMC), and Hydroxypropyl cellulose (HPC) were added to the raw materials as binders. The mixture of the raw materials and binders were then extruded through an extruder at an extrusion speed of 22±5 RPM to form cylindrical rods. The cylindrical rods were then spheronized at a speed of 510±5 RPM to produce microspheres. The microspheres were dried during spheronization with an inlet air temperature of 48±2° C. to a LOD of 10±2.5%.

After drying, the microspheres were coated with binder and the reserved acid and base to form an intermediate layer. FIG. 4 shows the resulting effervescent dosage forms 10.

The resulting effervescent dosage forms 10 were tested for sensory effects by dissolving them in 400 mL of room-temperature water. Three observers noted the phenomena and effects noted in Table 3.

TABLE 3

| Sensory | Phenomenon or | | | |
|---|---|---|---|---|
| Aspect | Effect | Observer A | Observer B | Observer C |
| Visual | Units tumbling in | X | X | X |
| | water | | | |
| | Solution gradually | X | X | X |
| | becomes | | | |
| | transparent | | | |
| | Presence of | O | O | O |
| | precipitates | | | |
| | Presence of oil | O | O | O |
| | film or floaters | | | |
| | Presence of | O | O | O |
| | insoluble particles | | | |
| | or aggregates | | | |
| Auditory | Bubbling sounds | X | X | X |
| | Collision sounds | X | O | X |
| Olfactory | Strawberry aroma | X | X | X |
| Gustatory | Strawberry flavor | X | X | X |
| | Bitter taste | O | O | O |
| | Oral irritation | O | O | O |

X = positive; O = negative

Table 4 notes the dissolution success and time for the effervescent dosage forms 10 of this Example in comparison to control group in triplicate. The control group consists of active ingredients without effervescent release technology.

TABLE 4

| | | Dissolution | Clear and Transparent |
|---|---|---|---|
| Groups | Sample Name | Time (min) | Solution |
| Example | Example Sample | 3 | X |
| Control Group | Control Sample 1 | 5 | O |
| | Control Sample 2 | 4 | O |
| | Control Sample 3 | 5 | O |

X = positive; O = negative

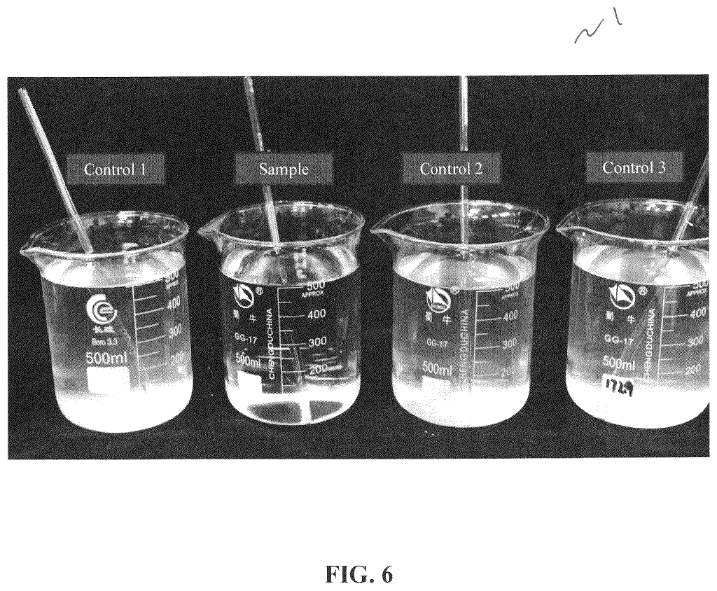

FIG. 6 shows the visual comparison of the effervescent dosage forms 10 of this Example in comparison to three control groups.

Table 5 compares creatine content between the Example sample and the control group under accelerated conditions, the accelerated conditions being an environmental temperature of 40° C.±2° C. and an environmental humidity of 75%±5% RH.

TABLE 5

| Item | Content of creatine monohydrate | | | | |
|---|---|---|---|---|---|
| Groups | initial | 1^{st} month | 2^{nd} month | 3^{rd} month | 6^{th} month |
| Sample group | 19% | 19% | 19% | 19% | 19% |
| Control group | 19% | 13% | 11% | 9% | 10% |

Table 6 compares calcium β-Hydroxy β-methylbutyric acid (CaHMB) content between the Example sample and the control group under accelerated conditions, the accelerated conditions being an environmental temperature of 40° C.±2° C. and an environmental humidity of 75%±5% RH.

TABLE 6

| Item | Content of CaHMB | | | | |
|---|---|---|---|---|---|
| Groups | initial | 1^{st} month | 2^{nd} month | 3^{rd} month | 6^{th} month |
| Sample group | 18% | 18% | 18% | 18% | 18% |
| Control group | 18% | 17% | 17% | 16% | 15% |

Table 7 compares package changing between the Example sample and the control group under accelerated conditions, the accelerated conditions being an environmental temperature of 40° C.±2° C. and an environmental humidity of 75%±5% RH.

TABLE 7

| Item | Appearance of package | | | | |
|---|---|---|---|---|---|
| Sample Amount | 3 individual packages per group | | | | |
| Groups | initial | 1^{st} month | 2^{nd} month | 3^{rd} month | 6^{th} month |
| Sample group | All normal | All | All | All | All |
| | | normal | normal | normal | normal |
| Control group | All normal | 2 inflated | All | All | All |
| | | | inflated | inflated | inflated |

### Example 2

In this Example, raw materials were weighed out as given in Table 8.

TABLE 8

| Components | Function | Input Percentage per Serving |
|---|---|---|
| Creatine Monohydrate | Active ingredient | 66 |
| Malate Acid | Effervescent agent | 18 |
| Sodium Bicarbonate | Effervescent agent | 9 |
| Gum Arabic | Shaping aid | 2 |
| Sodium Alginate | Binder | 3 |
| HPMC | Binder | 2 |
| Total | | 100 |

The raw materials were then passed through an 80 mesh sieve.

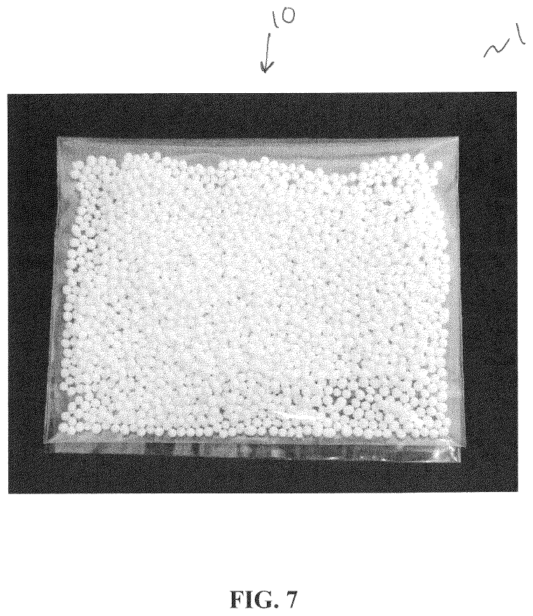

All raw materials, except for the binder and shaping aid, were added to a hopper mixer and mixed for 22±3 minutes. The mixed material and shaping aid were then added to a centrifugal granulator. The granulator was then set to 230±10 RPM with an inlet temperature of 48±3° C. The LOD was controlled between 8±1%. The material is then formed into microspheres in the centrifugal granulator. The binder was then sprayed onto the microspheres to form an outer coating 16. FIG. 7 shows the resulting effervescent dosage forms 10.

Table 9 notes the dissolution success and time for the effervescent dosage forms 10 of this Example in comparison to control group in triplicate. The control group consists of active ingredients without effervescent release technology.

TABLE 9

| Groups | Sample Name | Dissolution Time (min) |
|---|---|---|
| Example | Example Sample | 2 |
| Control Group | Control Sample 1 | 3 |
| | Control Sample 2 | 3 |
| | Control Sample 3 | 4 |

Table 10 shows the comparison of creatine content between the Example sample and the control group under accelerated conditions, the accelerated conditions being an environmental temperature of 40° C.±2° C. and an environmental humidity of 75%±5% RH.

TABLE 10

| Item | Content of creatine | | | | |
|---|---|---|---|---|---|
| Groups | initial | 1^{st} month | 2^{nd} month | 3^{rd} month | 6^{th} month |
| Sample group | 66% | 66% | 66% | 66% | 66% |
| Control group | 66% | 45% | 38% | 33% | 32% |

Table 11 shows the comparison of package changing between the Example sample and the control group under accelerated conditions, the accelerated conditions being an environmental temperature of 40° C.±2° C. and an environmental humidity of 75%±5% RH.

TABLE 11

| Item | Appearance of package | | | | |
|---|---|---|---|---|---|
| Sample amounts | 3 individual packages per group | | | | |
| Groups | Initial | 1^{st} month | 2^{nd} month | 3^{rd} month | 6^{th} month |
| Sample group | All | All | All | All | All |
| | normal | normal | normal | normal | normal |
| Control group | All | 1 inflated | 1 inflated | 2 inflated | 2 inflated |
| | normal | | | | |

### Example 3

In this Example, raw materials were weighed out as given in Table 12, except for 53% of the acid and base, which were set aside.

TABLE 12

| | | Input Percentage per |
|---|---|---|
| Components | Function | Serving |
| Creatine Monohydrate | Active ingredient | 55 |
| Sodium Hyaluronate | Active ingredient | 0.7 |
| L-Carnitine | Active ingredient | 0.7 |
| Paraxanthine | Active ingredient | 0.6 |
| Tartaric acid | Effervescent agent | 15 |
| Sodium Bicarbonate | Effervescent agent | 10 |
| Mannitol | Sweetener | 7 |
| Natural Peach Flavors | Flavor | 1 |
| Casein | Binder | 2 |
| HPMC | Binder | 3 |
| HPC | Binder | 2 |
| Stevia | Sweetener | 2 |
| Natural Fruit and Vegetable | Color | 1 |
| Powder | | |
| Total | | 100 |

The raw materials were then passed through a 60 mesh sieve. The acid used was tartaric acid and the base used was sodium bicarbonate in a 1.5:1 acid to base ratio.

Casein, HPMC, and HPC were added to the raw materials as binders. The mixture of the raw materials and binders were then extruded through an extruder at an extrusion speed of 35±5 RPM to form cylindrical rods. The cylindrical rods were then spheronized at a speed of 650±5 RPM to produce microspheres. The microspheres were dried during spheronization with an air inlet temperature of 50±2° C. to a LOD of 15±2%.

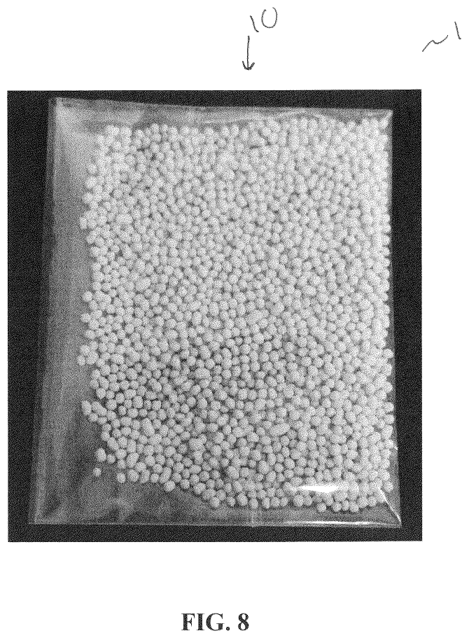

After drying, the microspheres were coated with binder and the reserved acid and base to form an intermediate layer. FIG. 8 shows the resulting effervescent dosage forms 10.

The resulting effervescent dosage forms 10 were tested for sensory effects by dissolving them in 400 mL of room-temperature water. Three observers noted the phenomena and effects noted in Table 13.

TABLE 13

| Sensory | Phenomenon or | | | |
|---|---|---|---|---|
| Aspect | Effect | Observer A | Observer B | Observer C |
| Visual | Units tumbling in | X | X | X |
| | water | | | |
| | Solution gradually | X | X | X |
| | becomes | | | |
| | transparent | | | |
| | Presence of | O | O | O |
| | precipitates | | | |
| | Presence of oil | O | O | O |
| | film or floaters | | | |
| | Presence of | O | O | O |
| | insoluble particles | | | |
| | or aggregates | | | |
| Auditory | Bubbling sounds | X | X | X |
| | Collision sounds | O | X | X |
| Olfactory | Peach aroma | X | X | X |
| Gustatory | Peach flavor | X | X | X |
| | Bitter taste | O | O | O |
| | Oral irritation | O | O | O |

Table 14 notes the dissolution success and time for the effervescent dosage forms 10 of this Example in comparison to control group in triplicate. The control group consists of active ingredients without effervescent release technology.

TABLE 14

| | Dissolution | Clear and | |
|---|---|---|---|
| Sample Name | Time (min) | Transparent Solution | Other Effects |
| Example | 3 | X | Cup wall is clear |
| Sample | | | |
| Control Sample | 5 | O | Residues on cup wall |

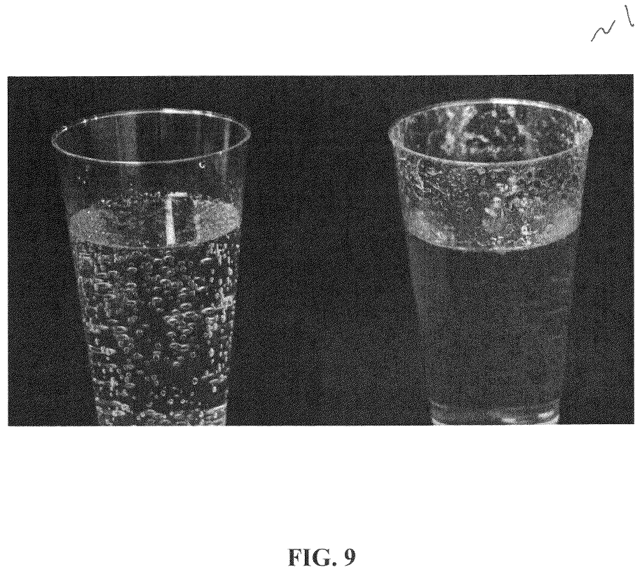

FIG. 9 provides a visual comparison of the dissolution effects between the example sample and the control group.

Although the disclosure has been described with reference to preferred embodiments, persons skilled in the art will recognize that changes may be made in form and detail without departing from the scope of the disclosed apparatus, systems and methods.

What is claimed is:

1. An effervescent dosage form for delivery of one or more active ingredients, comprising:
a core comprising the one or more active ingredients;
one or more concentric layers surrounding the core, wherein at least one of the one or more concentric layers comprises an effervescing agent, wherein the outermost concentric layer is configured to exclude environmental moisture,
wherein the dosage form leaves no visible precipitates or films when dissolved in water.

2. The dosage form of claim 1, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

3. The dosage form of claim 1, wherein the core further comprises one or more binders, wherein the binders are chosen from the list consisting of starch, maltodextrin, gum arabic, HPMC, HPC, chitosan, sodium alginate, and casein.

4. The dosage form of claim 3, wherein the dosage form is spherical, spheroidal, or ellipsoidal and wherein the diameter is from about 0.5 mm to about 8 mm.

5. The dosage form of claim 1, wherein the effervescent agents comprise acids and bases.

6. The dosage form of claim 5, wherein the acids are chosen from the list consisting of citric acid, malic acid, and tartaric acid, and
wherein the base is sodium bicarbonate

7. The dosage form of claim 6, wherein in the acid and base are present at a molar ratio of from about 1:1.2 to 2:1.

8. The dosage form 1, wherein the core comprises effervescent agents.

9. The dosage form of claim 1, wherein one or more concentric layers comprise from 1 to four layers.

10. A method of producing effervescent dosage forms comprising:
mixing raw materials with one or more binders to produce an unextruded mixture, the raw materials comprising an active ingredient, an acid, and a base;
extruding the unextruded mixture to produce cylindrical rods;
spheronizing the cylindrical rods to produce raw microspheres;
drying the raw microspheres to produce microspheres;
coating the microspheres with an outer film to produce effervescent dosage forms.

11. The method of claim 10, further comprising spraying an additional portion of one or more binders, an additional portion of an acid, and an additional portion of a base onto the microspheres.

12. The method of claim 11, wherein the raw materials are crushed and screened through a mesh sieve, the mesh sieve being about 60 mesh to about 100 mesh.

13. The method of claim 9, wherein the binders are chosen from the list consisting of starch, maltodextrin, gum arabic, HPMC, HPC, chitosan, sodium alginate, and casein.

14. The method of claim 9, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

15. A method of producing effervescent dosage forms comprising:
combining a primary mixture with a shaping aid, the primary mixture comprising an active ingredient, an acid, and a base;
granulating the primary mixture in a centrifugal granulator to produce raw microspheres;
spraying a binder onto the raw microspheres to produce microspheres;
coating the microspheres to produce effervescent dosage forms.

16. The method of claim 15, further comprising mixing raw materials together to produce the primary mixture; the raw materials comprising the active ingredient, the acid, and the base.

17. The method of claim 16, wherein the raw materials are crushed.

18. The method of claim 17, wherein the raw materials are screened through a mesh sieve, the mesh sieve being about 40 mesh to about 80 mesh.

19. The method of claim 15, wherein the active ingredient is chosen from the list consisting of branched-chain amino acids, creatine and hydrates thereof, sodium hyaluronate, β-hydroxy-β-methylbutyrate and salts thereof, amino acids, mineral chelates of amino acids, vitamins, minerals, peptides, proteins, L-carnitine, paraxanthine, dietary fiber, and glutathione.

20. The method of claim 15, wherein the shaping aid is chosen from the list consisting of starch, maltodextrin, and gum arabic.
